(19) United States
(12) Patent Application Publication
(10) Pub. No.: US 2025/0356236 A1
(43) Pub. Date: Nov. 20, 2025

(54) INDIVIDUAL QUBIT CONTROL FOR ATOM-ARRAY PROCESSORS

(71) Applicant: THE UNIVERSITY OF CHICAGO, Chicago, IL (US)

(72) Inventors: Hannes BERNIEN, Chicago, IL (US); Conor BRADLEY, Chicago, IL (US); Ryan WHITE, Chicago, IL (US)

(21) Appl. No.: 19/120,424

(22) PCT Filed: Oct. 13, 2023
(86) PCT No.: PCT/US2023/035151

§ 371 Date: Apr. 11, 2025

Related U.S. Application Data
(60) Provisional application No. 63/379,579, filed on Oct. 14, 2022.

(51) Int. Cl. G06N 10/40; G02F 1/33

(52) U.S. Cl. CPC G06N 10/40; G02F 1/33

(57) ABSTRACT

A system for individually controlling a plurality of qubits in an atom array includes a plurality of optical modulators and a fiber array having a plurality of optical fibers. Each of the optical fibers has an fiber input coupled to a modulator output of a respective one of the optical modulators. The system also includes a lens configured to image the output of the fiber array onto the qubits such that an fiber output of each of the optical fibers is imaged onto a respective one of the qubits. The lens may be a microscope objective. The system may also include a splitter that splits a single laser beam into a plurality of modulator-input beams such that each of the modulator-input beams is coupled to a respective one of the optical modulators. Each optical modulator may include an acousto-optic modulator, electro-optic modulator, mechanical shutter, or other optical component.

### RELATED APPLICATIONS

This application claims priority to U.S. Provisional Patent Application No. 63/379,579, filed on Oct. 14, 2022, which is incorporated herein by reference in its entirety.

### BACKGROUND

In recent years, arrays of neutral atomic qubits have emerged as a promising platform for quantum information processing and quantum simulation [1, 2]. In this architecture, individual atoms are trapped in tightly focused laser beams—optical tweezers—and the integration of reconfigurable tweezer arrays with cold-atom technology has led to the generation of atomic qubit arrays with hundreds of atoms [3-5]. Long-range, coherent interactions between atoms are realized by coupling to high principal quantum number states—Rydberg states—and have enabled the observation of large-scale entangled states [6], high-fidelity two-qubit and multi-qubit gates [7-9], the discovery of a new class of non-thermalizing quantum states called quantum many-body scars [10, 11] and the recent realization of a topological quantum spin liquid [12].

### SUMMARY

All of the above demonstrations were realized by coupling all of the atoms in the array simultaneously to a Rydberg state. Such “global” control leaves much to be desired, especially in the context of quantum algorithms where gate operations need to be atom selective. This requires individual atom addressing on fast timescales that are both compatible with the Rydberg lifetime, typically on the order of 100 μs, and the qubit coherence times, which are on the order of 1 s for qubits encoded in hyperfine states [13, 14].

There are multiple approaches for achieving individual atom selective control of the Rydberg interactions and qubit manipulations. For instance, small-scale quantum algorithms on five atoms have been realized by using acousto-optic deflectors to steer focused Rydberg excitation lasers onto selected atoms [15]. However, only one addressing beam was available, which limited the number of gate operations that could be carried out in parallel. A second demonstration relied on the coherent movement of atoms, which enabled two-qubit gates by bringing selected atoms close to each other [11]. While this approach offers exciting prospects with respect to qubit connectivity, moving atoms is a slow process which requires large amounts of space, potentially limiting the scalability of this technique.

The present embodiments include systems and methods for individually controlling qubits in atom-array processors. These embodiments enable site-selective operations, parallel gates that are much faster than both the Rydberg lifetime and qubit coherence times, and scalability to arrays with hundreds of atoms, or more. Some embodiments use a combination of a fiber array that is fed by a plurality of fiber-optic acousto-optic modulators (AOMs). The output of the fiber array is imaged on the atom array via a piezo steering mirror. In other embodiments, arrays of up to 1000 atoms, or more, are generated with a spatial light modulator (SLM) that generates control patterns in combination with a digital micromirror device (DMD) that switches these patterns on sub-millisecond timescales.

The present embodiments can be used with a dual-species, two-dimensional atom array in which one species is leveraged for the realization of control and readout of the other species. The present embodiments can be used to realize preparation protocols for large entangled states and to perform site-selective qubit readout within a large atom array without disturbing neighboring qubits. Moreover, the present embodiments will open up new avenues in the realization of quantum algorithms on atom-array processors, such as long-range Rydberg interactions and native three-qubit gates [7] to realize resource-efficient algorithm compilation. A theoretical analysis of such a compiler has shown a significantly reduced number of gates and shorter circuit depth when compiling benchmark algorithms [16].

The present embodiments may also be used for robust quantum random access memory (QRAM) [17]. Here, the system enables selective addressing of multiple layers of routing nodes that direct an input register to its associated memory cells. Furthermore, multiple memory registers can be selectively addressed with the same routing nodes, which would lead to more efficient QRAMs. The present embodiments may also be used to construct a quantum network node that combines atom arrays for generating, storing, and processing quantum information with photonic links that distribute entanglement between distant nodes.

### BRIEF DESCRIPTION OF THE FIGURES

FIG. 1 is a functional diagram of a system for individually controlling qubits that form an atom array, in accordance with some of the present embodiments.

FIG. 2A is a functional diagram of an atom-array processor that may be used to generate the atom array of FIG. 1.

FIG. 2B is a fluorescence image of the atom array of FIG. 1.

FIG. 2C are energy-level diagrams for rubidium and cesium.

FIG. 3A shows how Rydberg excitation beams may be applied globally to the atom array of FIG. 1 with counter-propagating laser beams.

FIG. 3B are plots showing Rabi oscillations between the ground state and the 70S Rydberg state of cesium.

FIG. 3C are plots showing Rabi oscillations of the hyperfine qubit states of cesium (top) and rubidium (bottom).

FIG. 4A is a diagram that illustrates cross-talk between neighboring atoms and uniformity of an addressing laser beam.

FIG. 4B is a plot of cross-talk for various values of atomic spacing.

FIG. 4C shows plots of the uniformity of the blue Rabi frequency at a targeted site of the atom array of FIG. 1.

FIG. 5 is a functional diagram of a system for individually controlling the qubits of the atom array of FIG. 1, in accordance with some of the present embodiments.

FIG. 6 is a functional diagram of a system for individually controlling the qubits of the atom array of FIG. 1, in accordance with some of the present embodiments.

### DETAILED DESCRIPTION

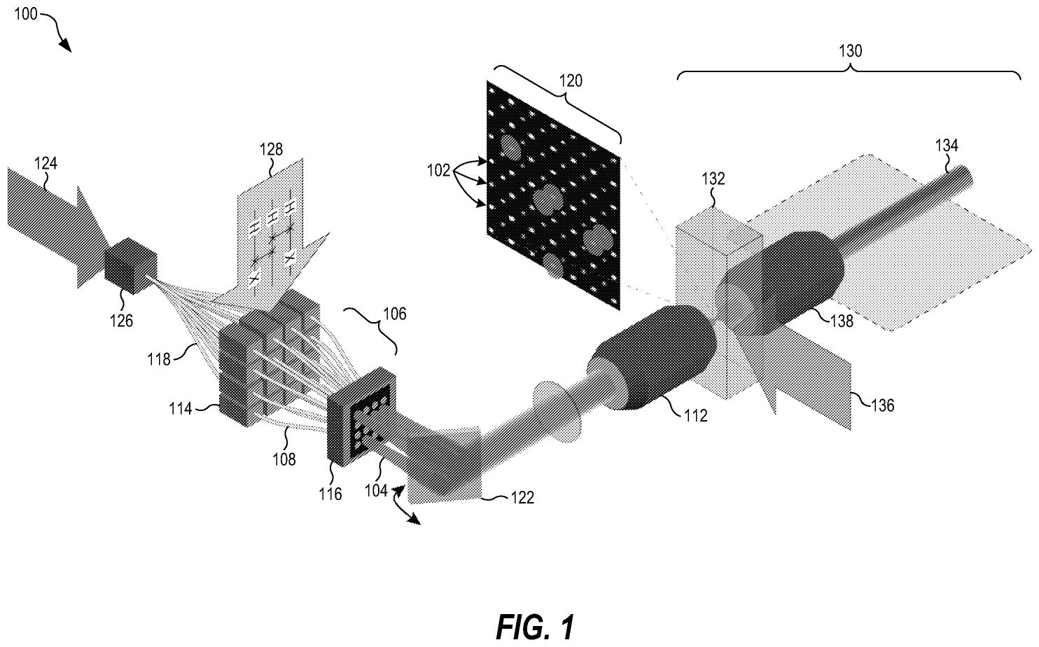

FIG. 1 is a functional diagram of a system 100 for controlling individual qubits 102 that form an atom array 120. The system 100 includes a plurality of optical modulators 114 that can be electronically controlled to simultaneously and individually modulate a respective plurality of local addressing beams 104. The system 100 also includes a fiber array 106 formed from a plurality of modulator-output optical fibers 108. Each of the optical fibers 108 is coupled to the output of a respective one of the optical modulators 114 such that the optical fibers 108 and optical modulators 114 form a one-to-one correspondence. The system 100 also includes a lens 112 for imaging the output 116 of the fiber array 106 onto the qubits 102. For clarity in FIG. 1, only one optical modulator 114 is labeled, only one optical fiber 108 is labeled, only one local addressing beam 104 is labeled, and only a few of the qubits 102 are labeled.

In some embodiments, the system 100 further includes an optical splitter 126 having an input port and a plurality of output ports. When an input laser beam 124 is coupled to the input port, the optical splitter 126 splits the input laser beam 124 into the plurality of optical beams 104. Each optical beam 104 is coupled out of the optical splitter 126, and into its respective optical modulator 114, via a respective one of the output ports. Thus, the output ports and optical modulators 114 form a one-to-one correspondence.

In the example of FIG. 1, each optical modulator 114 acts as a switch that can be electrically controlled (see electronic control signals 128) to transition between an “ON” position (i.e., the respective optical beam 104 passes into the respective optical fiber 108) and an “OFF” position (i.e., the respective optical beam 104 is blocked or diverted away from the respective optical fiber 108). In some embodiments, at least one of the optical modulators 114 is an acousto-optic modulator (AOM). Advantageously, AOMs have fast switching times (e.g., tens of nanoseconds) and high extinction in the “OFF” position. As described in more detail below, extinction is important since even very weak optical fields can erroneously drive qubits 102.

In some embodiments, at least one optical modulator 114 includes an electro-optic modulator (EOM). The EOM may be used to rotate polarization and cooperate with a polarizer to form an electro-optic amplitude modulator. Alternatively, the EOM may be used to modulate optical phase in one leg of a Mach-Zehnder interferometer. In any case, EOMs generally have switching times as fast as AOMs, but worse extinction. Accordingly, in one embodiment, at least one optical modulator 114 includes two or more EOMs that are connected in series and electrically driven simultaneously. In this case, the series of two or more EOMs benefits from the fast switching time but with higher extinction.

In some embodiments, at least one optical modulator 114 is a mechanical shutter. Mechanical shutters have very high extinction but relatively slow transition times. Nevertheless, a mechanical shutter traversing the waist of a tightly focused laser beam can achieve transition times below 100 μs. Mechanical shutters based on MEMS technology can also achieve transition times in the microsecond regime and can be easily integrated with optical fibers. Each optical modulator 114 may be a different type, or combination of different types, of optical modulator or optical switch known in the art. For example, each optical modulator 114 may combine a mechanical shutter with an EOM or an AOM.

As shown in FIG. 1, the lens 112 may be a microscope objective. However, the lens 112 may be another type of single lens, composite lens, or multi-lens system configured to image the output 116 of the fiber array 106 onto the qubits 102. The lens 112 may have a high or very high numerical aperture (NA). For example, the NA of the lens 112 may be greater than 0.4 or greater than 0.6. FIG. 1 also shows the optical modulators 114 and optical splitter 126 implemented as fiber-coupled components. In this case, each optical beam 104 is coupled into its respective optical modulator 114 via a respective one of a plurality of modulator-input optical fibers 118. For clarity in FIG. 1, only one of the optical fibers 118 is labeled. Alternatively, the optical modulators 114 and optical splitter 126 may be implemented as free-space components or a combination of free-space and fiber-coupled components.

In some embodiments, the system 100 further includes a scanning mirror 122 that is configured to scan (e.g., via electrical control) in one or two directions (e.g., tip, tilt, or both). The scanning mirror 122 is located between the output 116 of the fiber array 106 and the lens 112. Examples of the scanning mirror 122 include, but are not limited to, a galvanometer scan-head system and a mirror affixed to a kinematic mount with motorized or piezoelectric-controlled actuators. The scanning mirror 122 may use two or more mirrors that can fully translate the optical beams 104 in one or both transverse directions.

The scanning mirror 122 may be used to steer the optical beams 104 onto different portions of the atom array 120. For large atom arrays 120, there may be several hundred qubits 102, or more. In such cases, providing each qubit 102 with its own dedicated optical modulator 114 can be prohibitively expensive and complex. However, it is rare that all of the qubits 102 simultaneously need a dedicated optical modulator 114. Accordingly, a smaller number of optical modulators 114 (i.e., less than the number of qubits 102) may be used simultaneously, with the scanning mirror 122 reusing the same optical modulators 114 for different sections of the atom array 120. In FIG. 1, the system 100 has sixteen optical modulators 114 that can be used with up to sixteen of the qubits 102 simultaneously. However, the system 100 may alternatively have a different number of optical modulators 114. Similarly, while FIG. 1 shows the optical beams 104 forming a 4×4 square array, the optical beams 104 may form a different type or shape of array (e.g., 8×2, 16×1). The type and shape of the array may depend on how the qubits 102 are coupled to each other and the type of quantum circuit to be performed. In other embodiments, the number of optical modulators 114 equals the number of qubits 102, in which case each qubit 102 may have its own dedicated optical modulator 114. Also in this case, the scanning mirror 122 may no longer be needed and therefore excluded.

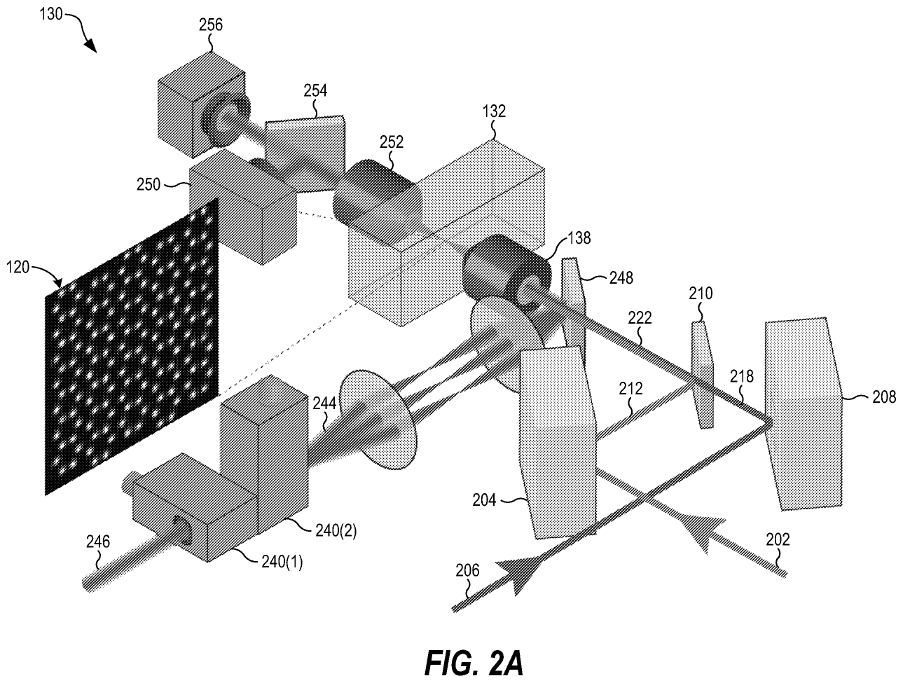

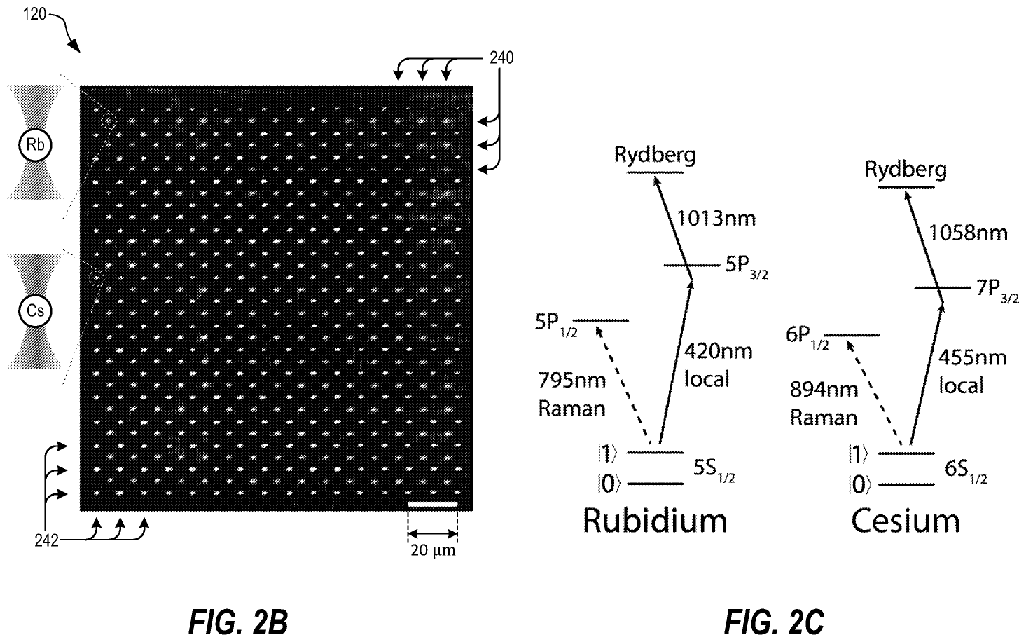

FIG. 1 also shows how the atom array 120 is part of a larger atom-array processor 130. The atom array 120 is located inside of a vacuum cell 132 with transparent walls, thereby allowing various laser beams (e.g., see laser beams 134 and 136) to pass into the interior vacuum region of the vacuum cell 132 and interact with the qubits 102. The transparency of the vacuum cell 132 also allows fluorescence emitted by the qubits 102 to reach a detector (e.g., see EMCCD detector in FIG. 2). The atom-array processor 130 also includes components (e.g., lasers, optics, vacuum components, magnetic field sources, control electronics, measurement electronics, microwave horns, etc.) for cooling the atoms, generating optical tweezers and projecting the optical tweezers into the vacuum cell 132 (e.g., via a high-NA lens 138), loading cold atoms into the optical tweezers to produce atom array 120, driving the atoms (e.g., to implement a quantum circuit), exciting the atoms (e.g., to Rydberg states), measuring the atoms (e.g., via laser-induced fluorescence), and various other tasks. Accordingly, the atom-array processor 130 may be used as part of a quantum computer, a quantum random-access memory (QRAM), a quantum metrology system (e.g., a magnetometer), an atomic clock, or another type of system or apparatus that uses trapped atoms.

In FIG. 1, the atom array 120 is a two-dimensional (2D) array that lies in a plane between the lens 112 and the lens 138. Specifically, the lens 112 and 138 are aligned to coincide with the same optical axis that passes perpendicularly through a pair of opposing walls of the vacuum cell 132. The atom array 120 lies flat in the plane transverse to this optical axis. With this geometry, light passing through each of the lenses 112 and 138 can be shaped to interact with specific qubits 102, and without interacting with other qubits 102. The optical beams 104 are examples of such light. A light beam having this ability to illuminate only one specified qubit 102 is referred to herein as a “local” light beam. By contrast, a light beam that illuminates all of the qubits 102 simultaneously is referred to herein as a “global” light beam. In FIG. 1, the laser beam 136 is an example of a global light beam.

While FIG. 1 shows the vacuum cell 132 as being fabricated entirely of a transparent material (e.g., glass or sapphire), the vacuum cell 132 may alternatively be a vacuum chamber (e.g., made of stainless steel) with windows or viewports that provide optical access to the vacuum region. Such windows may be anti-reflection coated. Similarly, the walls of the vacuum cell 132 may be anti-reflection coated. While FIG. 1 shows the lenses 112 and 138 as being outside of the vacuum cell 132, one or both of the lenses 112 and 138 may alternatively be located inside the vacuum cell 132 or vacuum chamber.

In some embodiments, the system 100 is a stand-alone device or apparatus that is separate from the atom-array processor 130. In other embodiments, the atom-array processor 130 includes the system 100. In some embodiments, the system 100 includes one or more lasers for generating the laser beam 124. As described in more detail below, the laser beam 124 may be used to help excite one or more specified qubits 102 to high-energy Rydberg levels. The laser beam 124 may be monochromatic or polychromatic (i.e., having two or more frequency components). When the laser beam 124 is polychromatic, the laser beam 124 may be created by combining two or more monochromatic laser beams, frequency modulating a monochromatic laser beam, or a combination thereof. When the laser beam 124 is created by combining two or more monochromatic laser beams, each of the two or more monochromatic laser beams may be individually modulated prior to combining. Such modulation allows the powers of the frequency components to be individually controlled.

FIG. 2A shows more detail of the atom-array processor 130. FIG. 2B is a fluorescence image of the atom array 120. FIG. 2C are energy-level diagrams for rubidium and cesium. FIGS. 2A-2C are best viewed together with the following description. As shown in FIGS. 1 and 2A-2C, the atom array 120 is dual species. Specifically, each qubit 102 is one of two different atomic species. For example, each of the qubits 102 may be a rubidium atom or a cesium atom. In general, each of the two atomic species may be any atomic element that can be laser cooled and optically trapped. Examples of such atomic elements include, but are not limited to, alkali metals, alkaline-earth metals, noble gases, and transition metals. Alternatively, the two atomic species may be two different isotopes of the same atomic element (e.g., ⁸⁵Rb and ⁸⁷Rb, ³⁹K and ⁴¹K, etc.). While the qubits 102 are described herein as forming an “atom array,” those trained in the art will recognize that a molecular species could be used in place of one or both of the two atomic species, provided that the molecular species can be laser cooled and optically trapped. The present embodiments may also be extended to more than two species. While the atom array 120 is shown as a 2D array, the atom array 120 may alternatively be a one-dimensional (1D) array or a three-dimensional (3D) array.

FIG. 2B shows how the atom array 120 may be a composite array formed from two superimposed arrays. The atom array 120 has a rubidium array 240 that only traps rubidium atoms and a cesium array 242 that only traps cesium atoms. The rubidium array 240 and cesium array 242 are spatially overlapped and transversely displaced such that each cesium atom resides at the center of a square formed by the four nearest rubidium atoms (and vice versa). The atom array 120 may be configured differently without departing from the scope hereof. Similarly, one or both of the rubidium array 240 and the cesium array 242 may have a different configuration other than square (e.g., rectangular, triangular, parallelogram, etc.). In FIG. 2B, the arrays 240 and 242 both have a spacing of approximately 10 μm. However, one or both of the arrays 240 and 242 may have a spacing other than 10 μm. While FIG. 2B shows the atom array 120 as having rows and columns that alternate between rubidium and cesium, the atom array 120 may be configured differently, as determined by the geometries of the arrays 240 and 242 and how the arrays 240 and 242 are spatially overlapped.

More generally, the atom array 120 may be a composite of n single-species atom arrays that are spatially superimposed over each other, where n is any positive integer indicating the integral number of different species that are trapped (n=2 for the dual-species atom array 120 shown in the figures). Each single-species atom array is created from an optical-tweezers array that is generated from a single monochromatic laser beam. For example, in FIG. 2A, a rubidium laser beam 202 (e.g., having a wavelength near 840 nm) is modulated by a first spatial light modulator (SLM) 204 to create a first optical-tweezers array 212 for trapping rubidium atoms in the rubidium array 240. Similarly, a cesium laser beam 204 (e.g. having a wavelength near 910 nm) is modulated by a second SLM 208 to create a second optical-tweezers array 218 for trapping cesium atoms in the cesium array 242. A dichroic beamsplitter 210 combines the optical-tweezers arrays 212 and 218 into a composite optical beam 222. The lens 138 then projects the composite optical beam 222 into the vacuum cell 132. The composite optical beam 222 is an example of the laser beam 134 of FIG. 1.

FIG. 2A also shows how the atom-array processor 130 may include a pair of crossed acousto-optic deflectors (AODs) 240(1) and 240(2) that modulate a laser beam 246 into a modulated laser beam 244 that is used to rearrange atoms that are probabilistically loaded into the arrays 240 and 242. Thus, the modulated laser beam 244 fills empty lattice sites to ensure that both of the arrays 240 and 242 are defect-free. A dichroic beamsplitter 248 combines the modulated laser beam 244 with the composite optical beam 222. The lens 138 then projects the modulated laser beam 244 into the vacuum cell 132 with the composite optical beam 222.

FIG. 2A also shows how the atom-array processor 130 may include a camera 256 for monitoring optical beams (e.g., the composite optical beam 222) and a fluorescence camera 250 for recording fluorescence emitted by the atoms in the atom array 120. The fluorescence camera 250 may be an electron-multiplying charge-coupled device (EMCCD) camera. A lens 252 images the plane of the atom array 120 onto the cameras 250 and 256. A beamsplitter 254 splits light between the camera 250 and the camera 256. The camera 256 and beamsplitter 254 may be replaced with the system 100 of FIG. 1. In this case, the lens 112 of FIG. 1 and the lens 252 of FIG. 2A may be the same.

Single atoms trapped in optical tweezers are attractive qubits due to their long coherence times and indistinguishability. Furthermore, loading atoms into optical tweezers is experimentally less demanding than other approaches (e.g., loading of optical lattices) since advanced cooling methods such as evaporative cooling are not necessary. This significantly reduces the complexity of the setup and leads to a fast repetition rate of the experiments. However, the trapping mechanism is probabilistic [18] with a typical trap occupancy of 50-60% per trap, rendering this approach impractical for generating large, defect-free qubit arrays. Recently, this randomness has been overcome by using reconfigurable tweezer arrays and a rearrangement protocol to generate defect-free arrays in 1D [19], 2D [20, 21] and 3D [22, 23]. Coherent interactions between the atoms can be switched on by optically coupling to highly excited Rydberg states. These states lead to an enormously strong dipole-dipole interaction between atoms which scales as N¹¹, where N is the principal quantum number. For states with N≥70, the typical interaction range is larger than 10 μm. This range compares favorably to the typical tweezer spacing, which is on the order of a few micrometers (see FIG. 2B), making it possible to have multiple atoms interact strongly with each other.

The approach of combining optical tweezer arrays with rearrangement and coherent Rydberg interactions has enabled the study of quantum many-body effects [10, 12, 24-27] in a highly coherent and tunable setting. For example, previous work includes the observation of a new class of non-thermalizing quantum many-body states on an array of 51 atoms [10], called quantum-many body scars [28], and the observation of critical dynamics across a quantum phase transition [27].

In the field of quantum information processing, Rydberg interactions have been suggested as a means by which to realize two-qubit gates [29], which was later experimentally demonstrated [30, 31]. These implementations and follow-up experiments realized fidelities below theoretical predictions [32] and only recently new insights have been gained into the limitations of the coherent Rydberg control [33]. Overcoming these imperfections has led to the creation of high-fidelity entangled states between two atoms [7-9, 34].

FIGS. 2A-2C show the dual-species atom array 120. Dual-species and multiple-species atom arrays offer unique opportunities for realizing novel qubit control and readout techniques by leveraging two or more types of qubits that can be independently manipulated. We recently produced 2D dual-species atom arrays with arbitrary geometries [5]. An example of a 512-site dual-species atom array is shown in FIG. 2B. Furthermore, we have demonstrated that there is negligible cross-talk between the two atomic species, enabling us to realize a form of continuous-mode operation in which one atom array is replenished while the other atom array is trapped [5].

FIG. 2C shows the relevant atomic levels for qubit encoding and Rydberg interactions. Qubits are encoded in long-lived hyperfine states which have coherence times that can reach seconds [13, 14]. To excite to high-lying Rydberg states, we use a two-photon transition that consists of a blue laser field (e.g., 420 nm for rubidium and 455 nm for cesium) and an infrared field (e.g., 1013 nm for rubidium and 1058 nm for cesium).

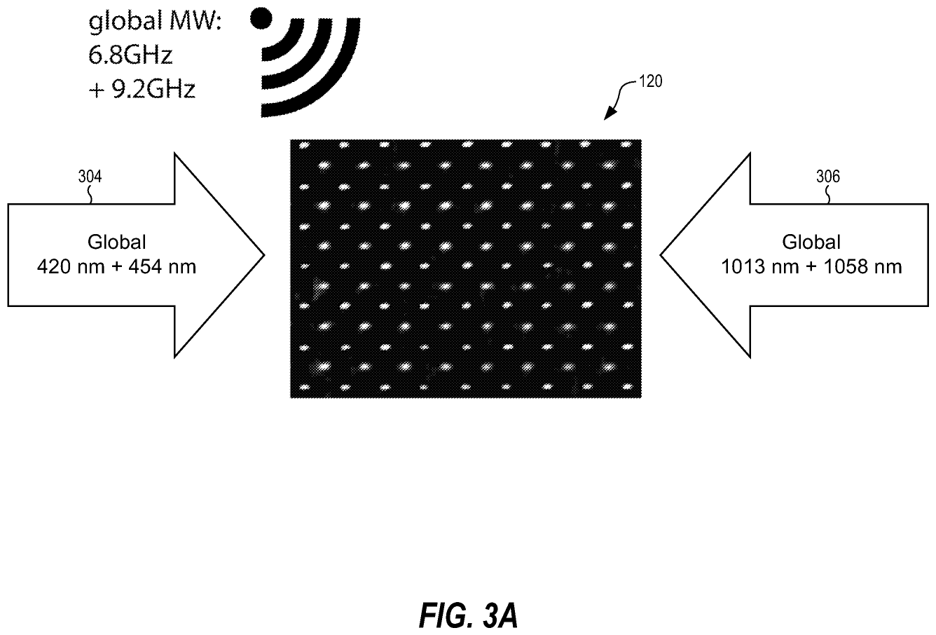

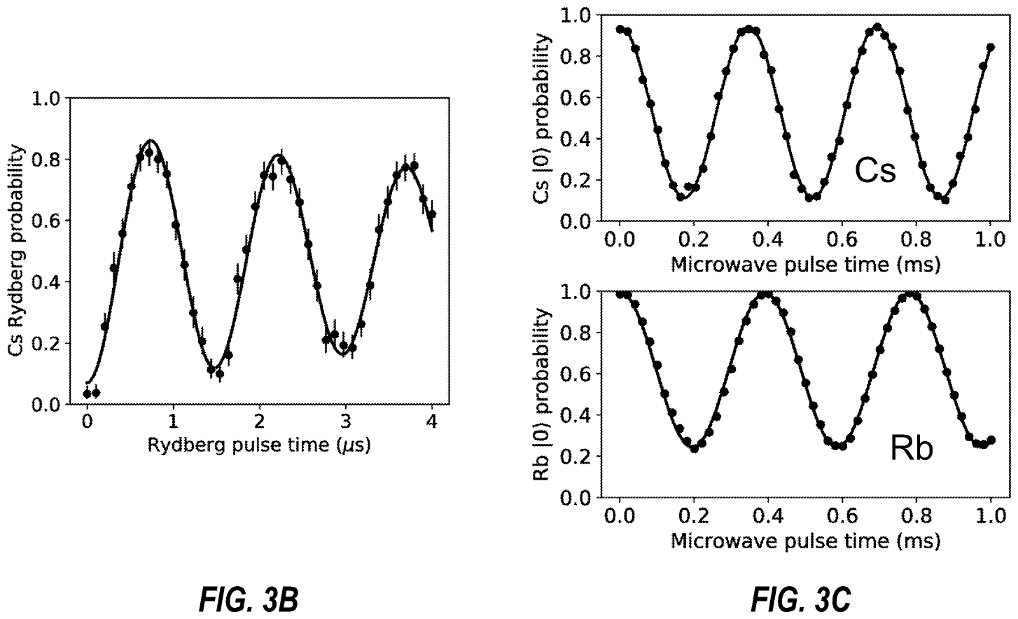

FIGS. 3A-3C illustrate coherent atom control. FIG. 3A shows how Rydberg excitation beams may be applied globally to the atom array 120 with counter-propagating laser beams 304 and 306. The laser beams 304 and 306 are also referred to herein as global addressing beams since they illuminate all of the qubits 102 simultaneously. The hyperfine qubit states are manipulated by applying microwaves (MW) with a microwave horn. FIG. 3B are plots showing Rabi oscillations between the ground state and the 70S Rydberg state of cesium. FIG. 3C are plots showing Rabi oscillations of the hyperfine qubit states of cesium (top) and rubidium (bottom). FIGS. 3A-3C are best viewed together with the following description.

As shown in FIG. 3A, control fields for hyperfine control and Rydberg control may be applied globally to the atom array 120. The laser beams 304 and 306, used for driving the two-photon transitions, counter-propagate in the plane of the atom array 120. This geometry reduces effects from random Doppler shifts due to the motion of the atoms inside the optical tweezers. Since both of the laser beams 304 and 306 are applied to the atoms simultaneously, we observe coherent oscillations between the ground state and the Rydberg state (see FIG. 3B). The decay of the oscillations is likely caused by laser intensity noise and position fluctuations [33]. Hyperfine qubit control may be realized by applying microwave radiation globally to the atom array 120 (e.g., with a microwave horn). For both rubidium and cesium, we observe coherent oscillations on millisecond timescales (see FIG. 3C). The oscillation frequency is limited by the geometry of the vacuum chamber and the power of the microwave horn.

Raman laser systems can dramatically increase the frequency from a few kilohertz to several megahertz [13], which is highly desirable for implementing algorithms with significant gate depth. These Raman transitions are realized using laser fields with wavelengths of 795 nm for rubidium and 894 nm for cesium (see FIG. 2C). The laser fields are modulated at microwave frequencies that match the respective qubit energy splittings to drive the |0 [symbol] →|1 [symbol] transitions while remaining sufficiently detuned from the intermediate excited states (5P_{1/2} and 6P_{1/2} for rubidium and cesium, respectively) to prevent their being populated [13].

The present embodiments perform site-selective control of the atom array 120 by carefully controlling the addressing laser fields such that subsets of atoms can be targeted in parallel and manipulated independently. Each atomic species requires many lasers to address its various transitions (e.g., Raman, Rydberg blue, Rydberg IR transitions, etc.; see FIG. 2C), so one might think that full individual control requires site-selectivity for every one of these fields, which would add a significant amount of complexity to the setup. However, a much more resource-efficient solution can be realized using site-selectivity of the blue Rydberg lasers alone (420 nm for rubidium and 455 nm for cesium). By applying this field on its own to a single site, the atom will experience a differential light shift of its hyperfine qubit states. This implements a site-selective, single-qubit phase gate [7, 15]. For two atoms that are within the Rydberg interaction radius, the application of the appropriate blue Rydberg fields in combination with the corresponding global infrared fields of the two-photon Rydberg transition (e.g., 1013 nm for rubidium and 1058 nm for cesium; see FIG. 2C) realizes a site-selective two-qubit gate. Note that such gates can be performed between all combinations of atomic species (cesium-cesium, cesium-rubidium, rubidium-rubidium), giving a high degree of versatility [35]. Together with global qubit rotations from the Raman lasers, this realizes full programmability of the atom array processor. Therefore, the present embodiments combine global Raman fields (e.g., 795 nm for rubidium and 894 nm for cesium) and global Rydberg fields in the infrared (e.g., 1013 nm for rubidium and 1058 nm for cesium) with local Rydberg fields in the blue (e.g., 420 nm for rubidium and 455 nm for cesium).

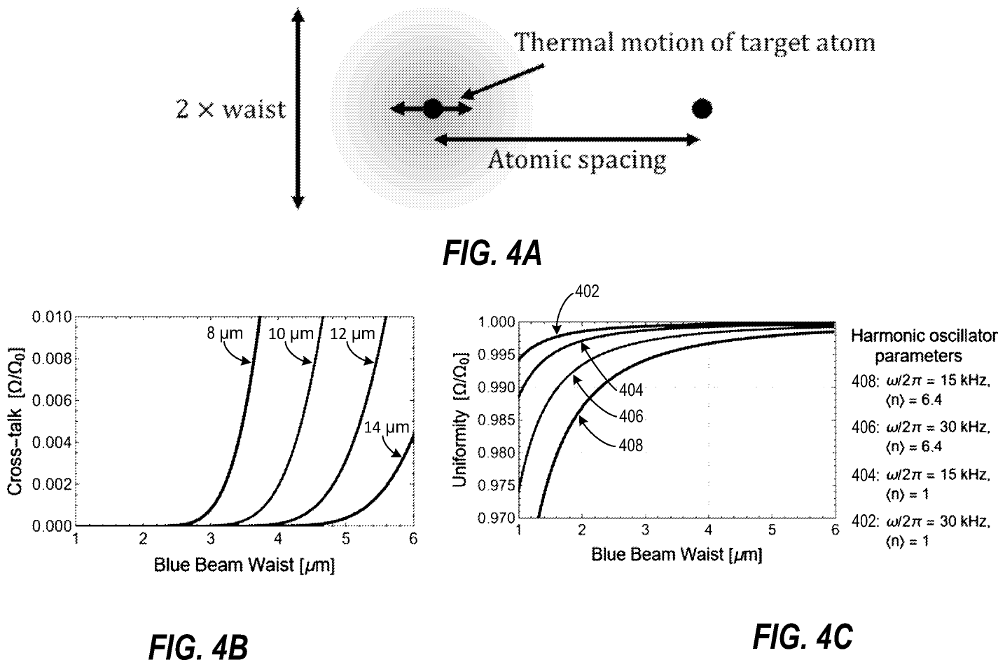

FIG. 4A is a diagram that illustrates cross-talk between neighboring atoms and uniformity of an addressing laser beam. Here, the left atom is addressed by a blue laser beam with a fixed waist while the neighboring atom on the right is not addressed. FIG. 4B is a plot of cross-talk (i.e., the fractional blue Rabi frequency Ω/Ω₀ experienced by a non-targeted atom when a neighboring atom is targeted with a blue Rabi frequency Ω₀ for various values of atomic spacing. FIG. 4C shows plots of the uniformity of the blue Rabi frequency at a targeted site of the atom array 120 of FIG. 1. Here, Ω/Ω₀ is the time-averaged fractional Rabi frequency for an atom in thermal motion with a motional state expectation value [symbol] n [symbol] axial harmonic trap frequency ω. The blue Rabi frequency Ω₀ experienced by an atom is stationary at the focus of the addressing beam. The values [symbol] n [symbol] =6.4 and ω=15 kHz correspond to current experimental parameters but performance can be improved with tighter traps (i.e., increasing ω), better cooling (i.e., decreasing [symbol] n [symbol] ), or both.

To realize high-fidelity single-qubit and two-qubit gates on selectively addressed atoms, the addressing beams should ideally have low cross-talk, high uniformity, and fast operations. First, the local addressing fields should induce the desired dynamics on the targeted atoms with minimal effect on neighboring atoms (see FIG. 4A). Such “cross-talk” can be quantified by the relative Rabi frequency on the blue transition (also referred to herein as the “blue Rabi frequency”) experienced by a neighboring atom when addressing a target, which should ideally be negligible. FIG. 4B is a plot of this frequency as a function of the waist of a Gaussian addressing beam. For reasonable values of the atomic spacing (e.g., 10 μm) we find that the cross-talk remains significantly below 1% for beam waists up to a few microns, which can be achieved with our present addressing optics. Moreover, tighter focuses, which would improve this metric, can be achieved with an objective (e.g., the lens 112 in FIG. 1) having a higher NA. These low cross-talk rates enable high-depth quantum circuits without suffering from parasitic residual entanglement between non-targeted qubit pairs or from having to compensate small single-qubit coherent errors which would otherwise build up and cause failure of an algorithm.

Second, to ensure reliable operations at each site, the addressing field ideally has sufficient uniformity such that the qubit dynamics are minimally affected by the thermal motion of the atoms within the harmonic optical-tweezer trapping potentials [36]. FIG. 4C shows the relative time-averaged blue Rabi frequency experienced by an atom in thermal motion, for two atomic temperatures (characterized by the motional state occupation number [symbol] n [symbol] ) and two radial trap frequencies ω, again as a function of the waist of the addressing beam. The higher occupation [symbol] n [symbol] =6.4 corresponds to atomic temperatures presently achieved in our experiments while an occupation of [symbol] n [symbol] =1 can be achieved by improved atomic cooling using techniques such as degenerate Raman sideband cooling or A-enhanced gray-molasses [37, 38]. Similarly, a trapping frequency of 15 kHz corresponds to presently generated optical tweezers, but an increase to 30 kHz could be achieved by increasing the trapping power. For all considered scenarios, a uniformity above 99% can be achieved with beam waists of 2-3 μm, sufficient to achieve high-fidelity operations (e.g., two-qubit gate infidelity <0.01% [11]).

Despite the intrinsic trade-off between these two factors, we find that an intermediate regime of ˜3 μm beam waists and ˜10 μm atomic spacing simultaneously satisfies the requirements for low cross-talk and high addressing uniformity. The present embodiments satisfy these geometric requirements.

Third, the blue Rabi frequencies should ideally be high since these determine the accessible gate speeds and consequently the number of gates which can be performed within the coherence times of the qubits. Moreover, it is important to ensure that there is no significant timing overhead in the control hardware. We present more details below with regards to these requirements, but here we give a brief outline. In general, we consider qubits which are encoded in long-lived hyperfine states and thus have long (>1 s) coherence and relaxation times [13, 14]. However, two-qubit gates can be implemented by exciting pairs of atoms into high-lying Rydberg states to engineer strong interactions. These Rydberg states have shorter lifetimes (˜100 μs) and so to achieve high-fidelity two-qubit gates, it is important that the optical Rydberg control pulses are performed on sub-microsecond timescales [33]. To ensure that this is feasible with our approaches, we have performed calculations of achievable Rabi frequencies for different atom array sizes based on optical loss measurements of our present equipment and conservative loss specifications for the requested equipment. These results are summarized below in Table 1. Despite dividing laser power across many sites to realize highly selective addressing of our atomic qubits, we still expect state-of-the-art Rydberg (two-photon) Rabi

TABLE 1
Calculated experimental parameters for two of the present embodiments.

| | | Number of | Blue laser | Blue Rabi | IR Rabi | Off-resonant | Differential | Rydberg Rabi | Rydberg |
|---|---|---|---|---|---|---|---|---|---|
| | | parallel | power | frequency | frequency | scattering | light shift | frequency | gates per |
| | Element | sites | [μW/atom] | [MHz] | [MHz] | rate [Hz] | [MHz] | [MHz] | millisecond |
| Fiber | Rb | 16 | 338.8 | 908.9 | 15.3 | 0.908 | 47.84 | 2.32 | 2320 |
| Array | Cs | 16 | 338.8 | 967.8 | 166.5 | 0.297 | 7.46 | 6.20 | 6198 |
| SLM + | Rb | 512 | 12.5 | 174.6 | 15.3 | 1.309 | 5.40 | 1.11 | 22 |
| DMD | Cs | 512 | 12.5 | 185.9 | 166.5 | 0.130 | 0.70 | 2.21 | 22 |

frequencies (MHz) due to the tight focuses of the lasers. Our calculations also show that these same features will enable site-selective, fast (also MHz) single-qubit phase gates using the differential light shifts induced by the blue Rydberg beams [7, 11, 15]. A higher NA increases the Rabi frequencies and differential light shifts in two ways: by decreasing waists, as discussed before, and by improving the laser transmission, thus increasing optical power.

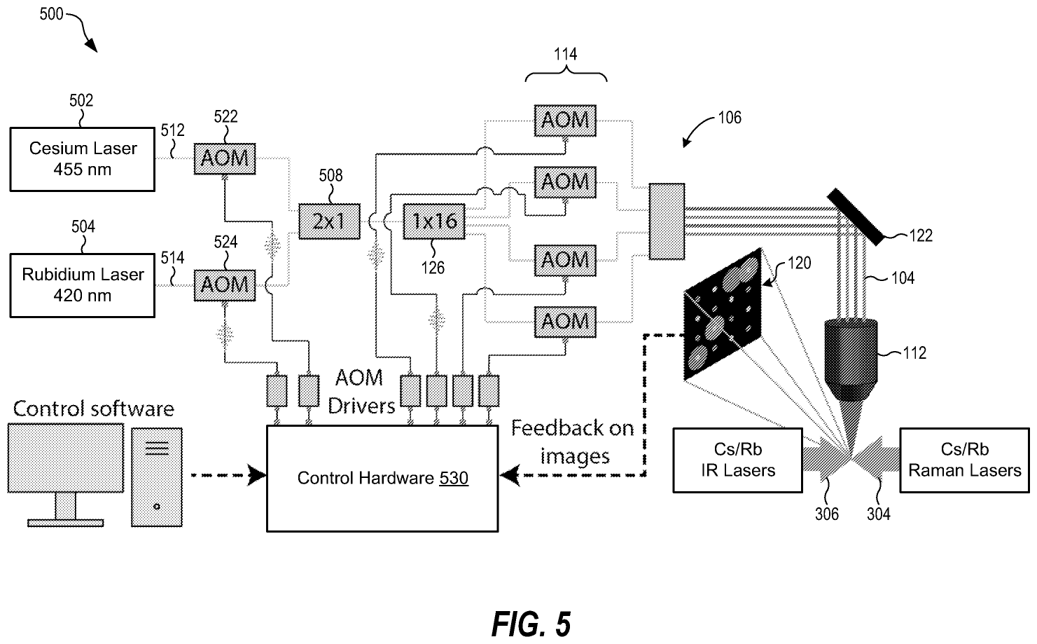

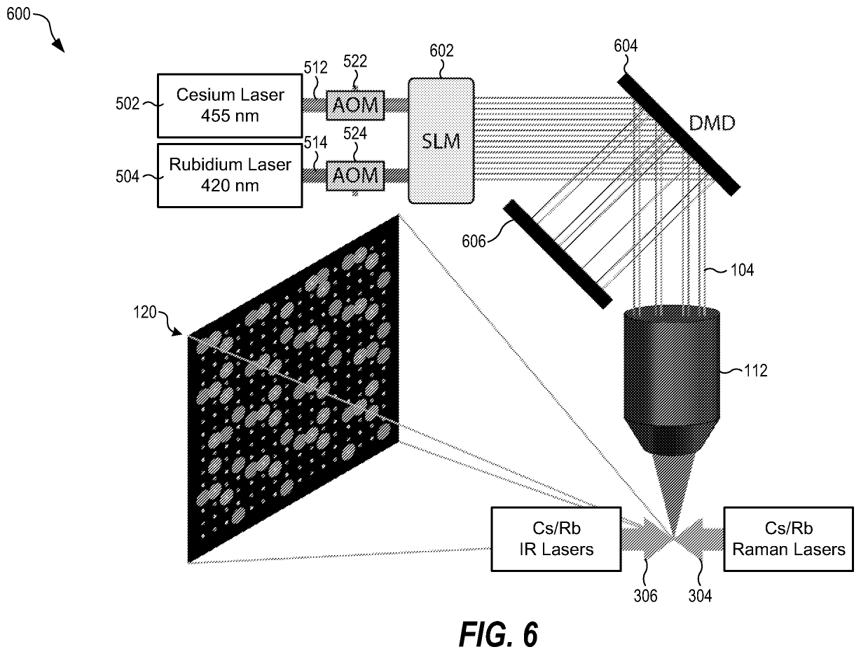

Table 1 shows experimental parameters for two of the present embodiments. Specifically, the entry labeled “Fiber Array” refers to the system 500 of FIG. 5. The entry labeled “SLM+DMD” refers to the system 600 of FIG. 6. Laser powers were determined from commercially available lasers as well as conservative estimates for losses through the various optical components. The given frequencies are upper limits and can be decreased if desired by attenuating the respective lasers. The term “Off-resonant scattering” refers to unintentional population of the intermediate state in the Rydberg transition and the laser detunings in each row (top to bottom: 3, 13, 1.2, and 7 GHz) are chosen to keep these rates low. As compared to the system 600, the system 500 can execute gates faster (i.e., has a higher gate rate) but with reduced parallelism. The system 600 has a gate rate limited by the switching time of the DMD but offers increased parallelism as compared to the system 500.

Acousto-optic modulators (AOMs) are routinely used in the field of quantum information science to dynamically change the amplitude of laser fields. In particular, they offer high-contrast on/off ratios (>30 dB), low insertion losses (<3 dB) and, critically, fast switching times of 10 ns. These speeds are compatible with the requirements for Rydberg Rabi frequencies (MHz, see Table 1) and much faster than the Rydberg lifetime and coherence time. A free-space AOM is often used to modulate a single beam, but has a large footprint and complicated alignment procedures, which quickly becomes prohibitive for scaling to many addressing beams. While multichannel AOMs on the market overcome some of these challenges, and have been used for site-selective addressing of ions in a 1D ion trap [39, 40], a major drawback is the restricted geometry with respect to the 2D nature of the atom array 120. Moreover, such multichannel AOMs are often used in conjunction with diffractive optical elements which are not well-suited to multi-species systems (utilizing distinct addressing wavelengths). Our alternative approach instead leverages 16 fiber-coupled AOMs (see the system 100 of FIG. 1). This fiber-based approach offers significantly reduced footprints, avoids alignment complications, and allows more geometric freedom by arranging the fiber outputs in a desired physical geometry. Crucially, the 16 fiber-coupled AOMs can be independently modulated, giving arbitrary control over the dynamics of up to 16 atoms in parallel.

FIG. 5 is a functional diagram of a system 500 for individually controlling the qubits 102 in the atom array 120. The system 500 is similar to the system 100 of FIG. 1 in that it includes the modulators 114, lens 112, scanning mirror 122, and optical splitter 126. For clarity in FIG. 5, only four of the modulators 114 are shown and no vacuum system is shown. In the following discussion, it is assumed that the atom array 120 traps rubidium and cesium atoms. However, as described above, the various components of the system 500 may be configured differently when other atomic species are used for the qubits 102. FIG. 5 also shows the global counterpropagating beams 304 and 306 illuminating the atom array 120, as described previously with respect to FIG. 3A.

In some embodiments, the system 500 includes a first global modulator 522 and a second global modulator 524. The first global modulator 522 is used for intensity stabilization and pulse shaping of a first laser beam 512 outputted by a first laser 502 (e.g., at 455 nm for driving Raman transitions in cesium; see FIG. 2C). The second global modulator 524 is used for intensity stabilization and pulse shaping of a second laser beam 514 outputted by a second laser 504 (e.g., at 420 nm for driving Raman transitions in rubidium; see FIG. 2C). A 2×1 optical combiner 508 combines the outputs of the global modulators 522 and 524 into a combined laser that propagate along a shared optical path (e.g., in free space or optical fiber) to the input of the optical splitter 126.

To permit feedback based on qubit measurements during an experiment (e.g., as used by protocols such as measurement-based quantum computation and quantum error correction), switching of the modulators 114 should be fast and support real-time updates of the control pulses (e.g., see electronic control signals 128 in FIG. 1) used to control the modulators 114. This capability can be implemented using specialized control hardware 530 with on-the-fly programmability and feedback. For example, the control hardware 530 may include a direct, low-latency interface to the camera 250 of FIG. 2, as used to perform fluorescence measurements on the qubit 102 [5].

The outputs of the AOMs are launched into the fiber array 106. The fiber array 106 may be formed of polarization-maintaining fibers and may have a geometry to produce an intended aspect ratio of the addressing beams at the qubits 102 (e.g., a 3:10 beam-to-waist pitch ratio can achieve 3-μm beam waists and a 10-μm pitch when focused on the atoms). Finally, the output of the fiber array 120 is imaged onto the qubits 102 using the lens 112 (e.g., a microscope objective) with a high numerical aperture to create the tight focuses (˜μm) that meet the geometry requirements discussed above.

The geometry of the accessible atomic sites is restricted by the geometry of the fiber array 106. For example, some commercially available fiber arrays form a 8×8 square array. However, not all of these 64 fibers are needed. For example, a selected subset of these 64 fibers can be coupled to the outputs of the 16 fiber AOMs, and can be rearranged between experiments, while the trapping positions of the atoms can be similarly updated between experiments by updating the pattern of the trapping SLMs [5, 20, 21]. This flexibility allows for the generation of highly-connected square grids (e.g., as widely studied for investigating surface codes for quantum error correction [41]) and other lattices, such as an 8×2 array (8 pairs of atoms) which could provide a resource for Bell-state distillation protocols [42].

An added benefit of this system 500 is modularity: individual fiber AOMs can be upgraded or replaced (e.g., in case of individual failure over component lifetimes of years) without compromising the performance of the other components or requiring a full reconfiguration of the system 500. Fiber-coupled AOMs also avoid the realignment procedures associated with the drift of free-space optical components.

With the system 500, up to 16 quantum gates can be implemented in parallel on 16 individual trapping sites which are selected by the geometry of the fiber array 106. The gate speeds offered by the system 500 are fast, with selective single-qubit and two-qubit gates both operating on sub-microsecond timescales. With the global Raman beams (e.g., the laser beam 304), global qubit rotations on sub-microsecond timescales can be implemented, thereby completing a universal gate-set for atomic qubits [13]. By contrast, direct microwave driving of atoms has gate speeds that are limited to hundreds of microseconds due to the geometry of the vacuum chamber and practical limits to microwave power.

With these clock rates, the system 500 can advantageously execute deep quantum circuits within the coherence times of hyperfine qubits. Furthermore, the system 500 supports other qubit modalities that have been explored for neutral atoms, such as ground-Rydberg and Rydberg-Rydberg encoding [1]. While these qubit modalities offer shorter qubit lifetimes and coherence times, they can be used to generate a variety of Hamiltonians which are of interest in the fields of quantum optimization, quantum simulation, and many-body physics [43-45]. To date, work on these modalities has predominantly been limited to global control techniques, whereas local control offers new opportunities for programmability and the study of otherwise inaccessible quantum observables [11].

While FIG. 5 shows the system 500 with 16 of the local addressing beams 104, the system 500 may include a greater number of the beams 104 and modulators 114, a fast-scanning piezo mirror can be used between the fiber array and the objective, which overcomes the restricted physical geometry of the fiber array itself.

The system 500 enables the application of high-speed single-qubit and two-qubit gates at the 16 spots illuminated by the fiber array 106 (MHz gate rates, see Table 1). These capabilities include characterizing, understanding, and improving the fundamental building blocks required for universal quantum information processing. Realizing this universal control in large (e.g., 1000 sites, or more) atom arrays, though, comes with additional challenges. In particular, the fiber array 106 only enables parallel gate application across a limited number of sites, limited by the number of AOMs. Although the scanning mirror 122 allows access to different subsets of atoms, its operational speeds are modest (˜1 ms), reducing the cycle rate of the architecture, while greater parallelism requires additional AOMs and hardware control channels (at additional cost and complexity).

FIG. 6 is a functional diagram of a system 600 for individually controlling the qubits 102 in the atom array 120. As compared to the system 500 of FIG. 5, the system 600 operates on a slower clock cycle but offers much greater parallelism as each trapping site in the atom array 120 has its own dedicated local addressing beam 104. Due to the slower clock cycle, this architecture is best used with qubits 102 encoded in long-lived hyperfine states [7, 13, 14]. Nevertheless, the system 500 can advantageously perform deep quantum circuits on atom arrays of 1000 atoms or more. FIG. 6 shows the global counterpropagating beams 304 and 306 illuminating the atom array 120, as described previously with respect to FIG. 3A.

The system 600 includes a spatial light modulator (SLM) 602 and a digital micromirror device (DMD) 604. SLMs are routinely used in present atom-array experiments to generate the optical tweezers which trap individual atoms (as described in Section 2.1) [20, 21]. In some of the present embodiments, an additional SLM generates a complementary matrix of laser spots using the blue Rydberg laser for each species. That is, each trapping site has its own addressing beam 104. Note that, in contrast to the system 500, which produces arrays of addressing beams 104 with a restricted geometry due to the physical structure of the fiber array 106, SLMs can be used to generate much more arbitrary images. Therefore, it is possible to trap and address atoms in a variety of alternative lattice structures beyond a square grid. This versatility allows for the study of efficient QRAM implementations, topologically-protected quantum states [12, 26, 46] and error-correction beyond the surface code [47].

In some embodiments, the system 600 uses the same global modulators 522 and 524 and same lasers 502 and 504 as shown in FIG. 5. While the SLM 602 can be controlled to generate arbitrary images, the switching speeds of SLMs are typically limited to 100 Hz, which restricts the number of gates which can be applied within the coherence times of any neutral-atom qubit modality. To overcome this speed limitation, the output of the SLM 602 is projected onto the DMD 604. The DMD is a micro-electrical-mechanical system (MEMS) having 106 individual mirrors, or pixel elements, with a pitch of 13.6 μm. Each mirror can be actuated independently between binary tilt angles of ±12° using bitstrings communicated across an efficient digital interface. Depending on the binary value chosen for each pixel, an incident laser beam is either deflected into the lens 112, where it is then focused onto an atom (pixel “on”) or deflected away from the lens 112 and into a beam dump 606 (pixel “off”).

With the system 600, cycles of simultaneous quantum gates (operating at MHz speeds by modulating the global modulators 522 and 524) can be applied to arbitrary subsets of the atom array 120 at a clock speed set by the DMD refresh rate. For state-of-the-art DMDs, this reaches 22 kHz, a two-order-of-magnitude improvement in speed over SLM technology. Moreover, the clock speeds are expected to improve as DMD hardware continues to develop. In each gate cycle, the chosen subset of atoms to be operated on is encoded in a single bitstring, with the capability to pre-load up to 80,000 of such bitstrings (80,000 gate cycles) onto the on-board memory of the DMD chipset. In addition, real-time feedback can be used with this architecture by live-streaming information to the DMD, either through video links (as for DMDs used in commercial projector applications) or through alternative, faster, information transfer protocols. This capability to feedback on measurement outcomes would enable protocols such as measurement-based quantum computation.

There are several technical benefits associated with the DMD 604. First, in a small footprint comparable to just a few fiber AOMs, thousands of local addressing beams 104 can be generated and controlled. Second, while the DMD 604 is a free-space optical component for which alignment may drift over time, any misalignment is common-mode to all of the local addressing beams 104, meaning that realignment or stabilization of the optical paths remain straightforward. Finally, operating in a blazed-grating configuration, the DMD 604 can be very power efficient, with achievable optical losses typically below 1.5 dB [48].

In Table 1, we present the calculated Rabi frequencies for Rydberg excitation with the system 600, as required for performing selective two-qubit gates, and the achievable differential light shifts, which enable selective single-qubit phase gates. These values are calculated considering the laser powers that are commercially available and taking conservative estimates for the losses through the various optical components. We find that it is possible to perform parallel two-qubit gates within a contiguous 1024-atom array with Rydberg Rabi frequencies comparable to those achieved in state-of-the-art, small-scale, neutral-atom quantum information processors [11, 15]. These Rabi frequencies, and the number of addressed sites, can be further improved in the future by independent upgrades of the Rydberg laser powers. Together with fast global single-qubit rotations, which will be achieved with the Raman laser systems described above, the calculated blue Rabi frequencies enable selective single-qubit phase gates and two-qubit gates on sub-microsecond timescales, meaning that the clock rate of the system 600 is limited by the DMD refresh rate of 22 kHz. Compared with the 1-s coherence times that can be achieved for neutral-atom qubits encoded in long-lived hyperfine states [13, 14], the system 500 can therefore be used to perform deep quantum circuits.

For comparison, the system 500 offers slightly higher Rabi frequencies and faster clock cycles (limited by the AOMs themselves rather than the DMD refresh rate), at the cost of significantly fewer parallel channels. We therefore envision that the architectures of FIG. 5 and FIG. 6 could also be integrated simultaneously to provide access to a modest number of fast quantum channels, and a large number of slower channels.

### REFERENCES

[1] M. Morgado and S. Whitlock, AVS Quantum Sci. 3, 023501 (2021).
[2] A. Browaeys and T. Lahaye, Nat. Phys. 16, 132-142 (2020).
[3] S. Ebadi et al., Nature 595, 227-232 (2021).
[4] P. Scholl et al., Nature 595, 233-238 (2021).
[5] K. Singh et al., Phys. Rev. X 12, 011040 (2022).
[6] A. Omran et al., Science 365, 570-574 (2019).
[7] H. Levine et al., Phys. Rev. Lett. 123, 170503 (2019).
[8] T. M. Graham et al., Phys. Rev. Lett. 123, 230501 (2019).
[9] I. S. Madjarov et al., Nat. Phys. 16, 857-861 (2020).
[10] H. Bernien et al., Nature 551, 579-584 (2017).
[11] D. Bluvstein et al., Nature 604, 451-456 (2022).
[12] G. Semeghini et al., Science 374, 1242-1247 (2021).
[13] H. Levine et al., Phys. Rev. A 105, 032618 (2022).
[14] Y. Wang, X. Zhang, T. A. Corcovilos, A. Kumar, and D. S. Weiss, Phys. Rev. Lett. 115, 043003 (2015).
[15] T. M. Graham et al., Nature 604, 457-462 (2022).
[16] J. M. Baker, A. Litteken, C. Duckering, H. Hoffmann, H. Bernien, and F. T. Chong, 2021 ACM/IEEE 48th Annual International Symposium on Computer Architecture (ISCA) 00:818-831 (2021).
[17] V. Giovannetti, S. Lloyd, and L. Maccone, Phys. Rev. Lett. 100, 160501 (2007).
[18] N. Schlosser, G. Reymond, I. Protsenko, and P. Grangier, Nature 411, 1024-1027 (2001).
[19] M. Endres et al., Science 354, 1024-1027 (2016).
[20] D. Barredo et al., Science 354, 1021-1023 (2016).
[21] H. Kim et al., Nat. Commun. 7, 13317 (2016).
[22] D. Barredo, V. Lienhard, S. de Léséleuc, T. Lahaye, and A. Browaeys, Nature 561, 79-82 (2018).
[23] A. Kumar, T.-Y. Wu, F. Giraldo, and D. S. Weiss, Nature 561, 83-87 (2018).
[24] H. Labuhn et al., Nature 534, 667-670 (2016).
[25] H. Kim, Y. Park, K. Kim, H. S. Sim, and J. Ahn, Phys. Rev. Lett. 120, 180502 (2018).
[26] S. de Léséleuc et al., Science 365, 775-780 (2019).
[27] A. Keesling et al., Nature 568, 207-211 (2019).
[28] C. J. Turner, A. A. Michailidis, D. A. Abanin, M. Serbyn, and Z. Papić, Nat. Phys. 14, 745-749 (2018).
[29] D. Jaksch, J. I. Cirac, P. Zoller, S. L. Rolston, R. Côté, and M. D. Lukin, Phys. Rev. Lett. 85, 2208-2211 (2000).
[30] L. Isenhower, E. Urban, X. L. Zhang, A. T. Gill, T. Henage, T. A. Johnson, T. G. Walker, and M. Saffman, Phys. Rev. Lett. 104, 010503 (2010).
[31] T. Wilk, A. Gaetan, C. Evellin, J. Wolters, Y. Miroshnychenko, P. Grangier, and A. Browaeys, Phys. Rev. Lett. 104, 010502 (2010).
[32] M. Saffman, J. Phys. B: At. Mol. Opt. Phys. 49, 202001 (2016).
[33] S. de Léséleuc, D. Barredo, V. Lienhard, A. Browaeys, and T. Lahaye, Phys. Rev. A 97, 053803 (2018).
[34] H. Levine et al., Phys. Rev. Lett. 121, 123603 (2018).
[35] I. I. Beterov and M. Saffman, Phys. Rev. A 92, 042710 (2015).
[36] A. M. Kaufman, B. J. Lester, and C. A. Regal, Phys. Rev. X 2, 041014 (2012).
[37] V. Vuletić, C. Chin, A. J. Kerman, and S. Chu, Phys. Rev. Lett. 81, 5768-5771 (1998).
[38] Y.-F. Hsiao, Y.-J. Lin, and Y.-C. Chen, Phys. Rev. A 98, 033149 (2018).
[39] S. Debnath, N. M. Linke, C. Figgatt, K. A. Landsman, K. Wright, and C. Monroe, Nature 536, 63-66 (2016).
[40] K. Wright et al., Nat. Commun. 10, 1-6 (2019).
[41] J. M. Auger, S. Bergamini, and D. E. Browne, Phys. Rev. A 96, 052320 (2017).
[42] C. H. Bennett, G. Brassard, S. Popescu, B. Schumacher, J. A. Smolin, and W. K. Wootters, Phys. Rev. Lett. 76, 722-725 (1996).
[43] S. Ebadi et al., Science 376, 1209-1215 (2022).
[44] P. Scholl et al., PRX Quantum 3, 020303 (2022).
[45] J. Choi, et al., arXiv:2103.03535 (2021).
[46] S. Weber et al., Quantum Sci. Tech. 3, 044001 (2018).
[47] O. Higgott and N. P. Breuckmann, Phys. Rev. X 11, 031039 (2021).
[48] Texas Instruments, DMD Optical Efficiency for Visible Wavelengths, Application Note (2019).

### Combinations of Features

Features described above as well as those claimed below may be combined in various ways without departing from the scope hereof. The following examples illustrate possible, non-limiting combinations of features and embodiments described above. It should be clear that other changes and modifications may be made to the present embodiments without departing from the spirit and scope of this invention:

(A1) A system for individually controlling a plurality of qubits includes a plurality of optical modulators and a fiber array having a plurality of optical fibers. Each of the plurality of optical fibers has an optical-fiber input that is coupled to a modulator output of a respective one of the plurality of optical modulators. The system also includes a lens configured to image a fiber-array output of the fiber array onto the plurality of qubits such that an optical-fiber output of each of the plurality of optical fibers is imaged onto a respective one of the plurality of qubits.

(A2) In the system denoted (A1), each of the plurality of optical modulators includes an acousto-optic modulator, an electro-optic modulator, an optical shutter, or a combination thereof.

(A3) In either of the systems denoted (A1) and (A2), each of the plurality of optical modulators is fiber-coupled.

(A4) In any of the systems denoted (A1) to (A3), the plurality of optical fibers form a two-dimensional array.

(A5) In any of the systems denoted (A1) to (A4), the lens includes a microscope objective.

(A6) In any of the systems denoted (A1) to (A5), the system further includes an optical splitter having a plurality of splitter outputs. Each of the plurality of splitter outputs is coupled to a modulator input of a respective one of the plurality of optical modulators.

(A7) In the system denoted (A6), the optical splitter is fiber coupled.

(A8) In either of the systems denoted (A6) and (A7), the system further includes an optical combiner having a combiner output that is coupled to a splitter input of the optical splitter.

(A9) In the system denoted (A8), the system further includes a first modulator, separate from the plurality of optical modulators, having a first modulator output that is coupled to a first combiner input of the optical combiner. The system further includes a second modulator, separate from the plurality of optical modulators, having a second modulator output that is coupled to a second combiner input of the optical combiner.

(A10) In the system denoted (A9), each of the first and second modulators is fiber coupled.

(A11) In either of the systems denoted (A9) and (A10), the system further includes a first laser having a first laser output that is coupled to a first modulator input of the first modulator. The system further includes a second laser having a second laser output that is coupled to a second modulator input of the second modulator.

(A12) In any of the systems denoted (A1) to (A11), the system further includes a scanning mirror located between the fiber-array output and the lens. The scanning mirror is configured to steer light from the fiber-array output into the lens.

(A13) In any of the systems denoted (A1) to (A12), the system further includes a vacuum system having a window through which light from the fiber-array output can pass to illuminate one or more of the plurality of qubits.

(A14) In the system denoted (A13), the lens is located outside of the vacuum system.

(A15) In any of the systems denoted (A1) to (A14), the plurality of qubits are neutral atoms.

(A16) In the system denoted (A15), the plurality of qubits include more than one atomic species.

(B1) A method for individually controlling a plurality of qubits includes simultaneously coupling a plurality of modulator-input laser beams into a respective plurality of optical modulators. The method also includes driving the plurality of optical modulators to transmit one or more of the plurality of modulator-input laser beams through one or more of the plurality of optical modulators as one or more local addressing beams, respectively. The method also includes coupling a modulator output of each of the plurality of optical modulators into an optical-fiber input of a respective one of a plurality of optical fibers of a fiber array. The method also includes imaging, with a lens, a fiber-array output of the fiber array onto the plurality of qubits such that an optical-fiber output of each of the plurality of optical fibers is imaged onto a respective one of the plurality of qubits. The one or more local addressing beams are focused onto one or more locally addressed qubits, respectively, of the plurality of qubits.

(B2) In the method denoted (B1), each of the plurality of optical modulators is an acousto-optic modulator, an electro-optic modulator, an optical shutter, or a combination thereof.

(B3) In either of the methods denoted (B1) and (B2), each of the plurality of optical modulators is fiber-coupled.

(B4) In any of the methods denoted (B1) to (B3), the lens includes a microscope objective.

(B5) In any of the methods denoted (B1) to (B4), the method further includes splitting a single laser beam into the plurality of modulator-input laser beams.

(B6) In the method denoted (B5), the method further includes generating the single laser beam by combining a first laser beam and a second laser beam.

(B7) In the method denoted (B6), the method further includes modulating one or both of the first and second laser beams prior to said combining.

(B8) In either of the methods denoted (B5) and (B6), the method further includes generating the first laser beam with a first laser and generating the second laser beam with a second laser.

(B9) In any of the methods denoted (B1) to (B8), the method further includes scanning the one or more local addressing beams across an input of the lens.

(B10) In any of the methods denoted (B1) to (B9), the method further includes trapping the plurality of qubits inside of a vacuum system. Said imaging includes transmitting the one or more local addressing beams through a window of the vacuum system.

(B11) In the method denoted (B10), said trapping includes trapping at least two species of neutral atoms.

(B12) In any of the methods denoted (B1) to (B 11), the method further includes simultaneously illuminating all of the plurality of qubits with a global addressing beam.

(B13) In the method denoted (B12), the method further includes simultaneously driving, with the global addressing beam and the one or more local addressing beams, the same Raman transition in all of the one or more locally addressed qubits.

(B14) In the method denoted (B13), said driving includes driving all of the one or more locally addressed qubits into the same Rydberg level.

(C1) A system for individually controlling a plurality of qubits includes a spatial light modulator configured to spatially modulate a laser beam into a modulated laser beam having a plurality of spots. The system also includes a digital micromirror device having a plurality of pixel elements configured to steer the plurality of spots, respectively, between a first angular direction and a second angular direction. The system also includes a lens configured to focus one or more local addressing spots, of the plurality of spots and steered in the first angular direction, onto one or more locally addressed qubits, respectively, of the plurality of qubits.

(C2) In the system denoted (C1), the system further includes a beam dump configured to receive each of the plurality of spots steered in the second angular direction.

(C3) In either of the systems denoted (C1) and (C2), the lens includes a microscope objective.

(C4) In any of the systems denoted (C1) to (C3), the system further includes an optical combiner having a combiner output that is coupled to the spatial light modulator.

(C5) In the system denoted (C4), the system further includes a first optical modulator having a first modulator output coupled to a first combiner input of the optical combiner. The system also includes a second optical modulator having a second modulator output coupled to a second combiner input of the optical combiner.

(C6) In the system denoted (C5), each of the first and second optical modulators is an acousto-optic modulator or electro-optic modulator.

(C7) In either of the systems denoted (C5) and (C6), the system further includes a first laser having a first laser output that is coupled to a first modulator input of the first optical modulator. The system also includes a second laser having a second laser output that is coupled to a second modulator input of the second optical modulator.

(C8) In any of the systems denoted (C1) to (C7), the system further includes a vacuum system having a window through which the one or more local addressing spots can pass to illuminate the one or more locally addressed qubits.

(C9) In the system denoted (C8), the lens is located outside of the vacuum system.

(C10) In any of the systems denoted (C1) to (C9), the plurality of qubits are neutral atoms.

(C11) In the system denoted (C10), the plurality of qubits include more than one atomic species.

(D1) A method for individually controlling a plurality of qubits includes spatially modulating a modulator-input laser beam into a modulated laser beam having a plurality of spots. The method also includes steering, with each pixel element of a plurality of pixel elements of a digital micromirror device, a respective one of the plurality of spots in a first angular direction or a second angular direction. The method also includes focusing, with a lens, one or more local addressing spots, of the plurality of spots and steered in the first angular direction, onto one or more locally addressed qubits, respectively, of the plurality of qubits.

(D2) In the method denoted (D1), the lens includes a microscope objective.

(D3) In either of the methods denoted (D1) and (D2), the method further includes dumping a subset of the plurality of spots that are steered in the second angular direction.

(D4) In any of the methods denoted (D1) to (D3), the method further includes generating the modulator-input laser beam by combining a first laser beam and a second laser beam.

(D5) In the method denoted (D4), the method further includes modulating one or both of the first and second laser beams prior to said combining.

(D6) In either of the methods denoted (D4) and (D5), the method further includes generating the first laser beam with a first laser and generating the second laser beam with a second laser.

(D7) In any of the methods denoted (D1) to (D6), the method further includes trapping the plurality of qubits inside a vacuum system. Said imaging includes transmitting the one or more local addressing spots through a window of the vacuum system.

(D8) In the method denoted (D7), said trapping includes trapping at least two species of neutral atoms.

(D9) In any of the methods denoted (D1) to (D8), the method further includes simultaneously illuminating all of the plurality of qubits with a global addressing beam.

(D10) In the method denoted (D9), the method further includes simultaneously driving, with the global addressing beam and the one or more local addressing spots, the same Raman transition in all of the one or more locally addressed qubits.

(D11) In the method denoted (D10), said driving includes driving all of the one or more locally addressed qubits into the same Rydberg level.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

1. A system for individually controlling a plurality of qubits, comprising:
a plurality of optical modulators;
a fiber array comprising a plurality of optical fibers, each of the plurality of optical fibers having an optical-fiber input that is coupled to a modulator output of a respective one of the plurality of optical modulators; and
a lens configured to image a fiber-array output of the fiber array onto the plurality of qubits such that an optical-fiber output of each of the plurality of optical fibers is imaged onto a respective one of the plurality of qubits.

2. The system of claim 1, each of the plurality of optical modulators comprising an acousto-optic modulator, an electro-optic modulator, an optical shutter, or a combination thereof.

3. The system of claim 1, each of the plurality of optical modulators being fiber-coupled.

4. The system of claim 1, the plurality of optical fibers forming a two-dimensional array.

5. The system of claim 1, the lens comprising a microscope objective.

6. The system of claim 1, further comprising an optical splitter having a plurality of splitter outputs, each of the plurality of splitter outputs being coupled to a modulator input of a respective one of the plurality of optical modulators.

7. (canceled)

8. The system of claim 6, further comprising an optical combiner having a combiner output that is coupled to a splitter input of the optical splitter.

9. The system of claim 8, further comprising:
a first modulator, separate from the plurality of optical modulators, having a first modulator output that is coupled to a first combiner input of the optical combiner; and
a second modulator, separate from the plurality of optical modulators, having a second modulator output that is coupled to a second combiner input of the optical combiner.

10-11. (canceled)

12. The system of claim 1, further comprising a scanning mirror located between the fiber-array output and the lens, the scanning mirror being configured to steer light from the fiber-array output into the lens.

13-14. (canceled)

15. The system of claim 1, the plurality of qubits comprising neutral atoms of more than one atomic species.

16. (canceled)

17. A method for individually controlling a plurality of qubits, comprising:
simultaneously coupling a plurality of modulator-input laser beams into a respective plurality of optical modulators;
driving the plurality of optical modulators to transmit one or more of the plurality of modulator-input laser beams through one or more of the plurality of optical modulators as one or more local addressing beams, respectively;
coupling a modulator output of each of the plurality of optical modulators into an optical-fiber input of a respective one of a plurality of optical fibers of a fiber array; and
imaging, with a lens, a fiber-array output of the fiber array onto the plurality of qubits such that an optical-fiber output of each of the plurality of optical fibers is imaged onto a respective one of the plurality of qubits;
wherein the one or more local addressing beams are focused onto one or more locally addressed qubits, respectively, of the plurality of qubits.

18. The method of claim 17, each of the plurality of optical modulators comprising an acousto-optic modulator, an electro-optic modulator, an optical shutter, or a combination thereof.

19. The method of claim 17, each of the plurality of optical modulators being fiber-coupled.

20. (canceled)

21. The method of claim 17, further comprising splitting a single laser beam into the plurality of modulator-input laser beams.

22. The method of claim 21, further comprising generating the single laser beam by combining a first laser beam and a second laser beam.

23. The method of claim 22, further comprising modulating one or both of the first and second laser beams prior to said combining.

24. (canceled)

25. The method of claim 17, further comprising scanning the one or more local addressing beams across an input of the lens.

26-27. (canceled)

28. The method of claim 17, further comprising simultaneously illuminating all of the plurality of qubits with a global addressing beam.

29. The method of claim 28, further comprising simultaneously driving, with the global addressing beam and the one or more local addressing beams, the same Raman transition in all of the one or more locally addressed qubits.

30. The method of claim 29, wherein said driving comprises driving all of the one or more locally addressed qubits into the same Rydberg level.

31-52. (canceled)
